(19) United States
(12) Patent Application Publication
(10) Pub. No.: US 2006/0236876 A1
(43) Pub. Date: Oct. 26, 2006

(54) Panel filter assembly

(76) Inventor: Daniel W. Finley, Marietta, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/388,556

(22) Filed: Mar. 24, 2006

Related U.S. Application Data
(60) Provisional application No. 60/665,298, filed on Mar. 25, 2005.

(51) Int. Cl. A23N 1/00

(52) U.S. Cl. 99/495

(57) ABSTRACT

There is provided a panel filter assembly for particular use in commercial and industrial applications, as well as for residential use, that filter, reduce, or eliminate dust, odor, gas and particles from contaminated environments. The panel filter can be installed in portable or stationary air purification systems. It is designed to be lightweight, recyclable, and easily assembled. Certain components of the filter are adapted to be collapsed during shipping (and before complete assembly) to reduce space.

This application claims the benefit of U.S. Provisional Patent Application Ser. No. 60/665,298, filed Mar. 25, 2005 titled “Panel Filter Assembly,” the entire contents of which are incorporated here by reference.

### FIELD OF THE INVENTION

The present invention relates to panel filters for particular use in industrial and commercial applications to remove dust, odors, gases, and particles from contaminated environments.

### BACKGROUND

Contaminated environments can be hazardous for a number of reasons. For example, in machine shops, oil mist is created when metals are shaped and formed. Welding shops create fume and smoke. Wood-working shops create sawdust and other dust particulates. The extrusion of plastics, the molding of plastics and rubber, the processing of paper products, the use of photography chemicals, the use of ammonia and formaldehyde in hospitals and other laboratories, the smell of fish markets and processing plants, and the operations in spinning and weaving mills, all create contamination. In addition to those listed, many other manufacturing plants and commercial locations create dangerous gases, odors, or particles. These contaminants often cannot be prevented, and accordingly, they must be efficiently and economically controlled and/or removed.

Although particularly suited for industrial and commercial uses, there are also instances in residential use when quality air filtration (above and beyond that provided by air conditioner filters) is needed. For example, paint fumes, cleaning products, moth repellants, pet dander, smoke fumes, renovation work, and hobby supplies can all create unwanted fumes and odors that are desirably removed.

Many of the air filters currently on the market are manufactured for use with air purification systems, for example, those provided by Fumex, Inc. The filters are constructed of sheet metal, steel, fiberglass and/or various plastic substrates. These materials are heavy, and thus difficult to install or remove. Installation and removal can also be made more difficult because the filters can cause cutting, pinching, or other injuries during installation due to the sharp edges and additional weight. These filters are also expensive to manufacture and ship due to their weight, the materials used, and their design. They are also not recyclable, which causes additional environmental concerns for disposal. Accordingly, there is a need in the art for improved industrial, commercial and residential air filter assemblies to replace existing air purification filters.

### SUMMARY

There is provided a panel filter assembly according to certain embodiments of the invention for particular use in commercial and industrial applications, as well as for residential use, that filter, reduce, or eliminate dust, odor, gas and particles from contaminated environments. The panel filter according to certain embodiments can be installed in portable or stationary air purification systems and designed to be lightweight, recyclable, and easily assembled. Certain components of the filter may be adapted to be collapsed during shipping (and before complete assembly) to reduce space.

### BRIEF DESCRIPTION OF THE DRAWINGS

FIG. 1 shows a panel filter assembly according to certain embodiments of this invention.

FIG. 2 shows one embodiment of tray members prior to their assembly with additional filter components.

FIGS. 3 and 4 show one embodiment of a blank that may be used to manufacture tray members.

FIG. 5 shows an exploded perspective view of an air filter according to one embodiment of the invention.

### DETAILED DESCRIPTION

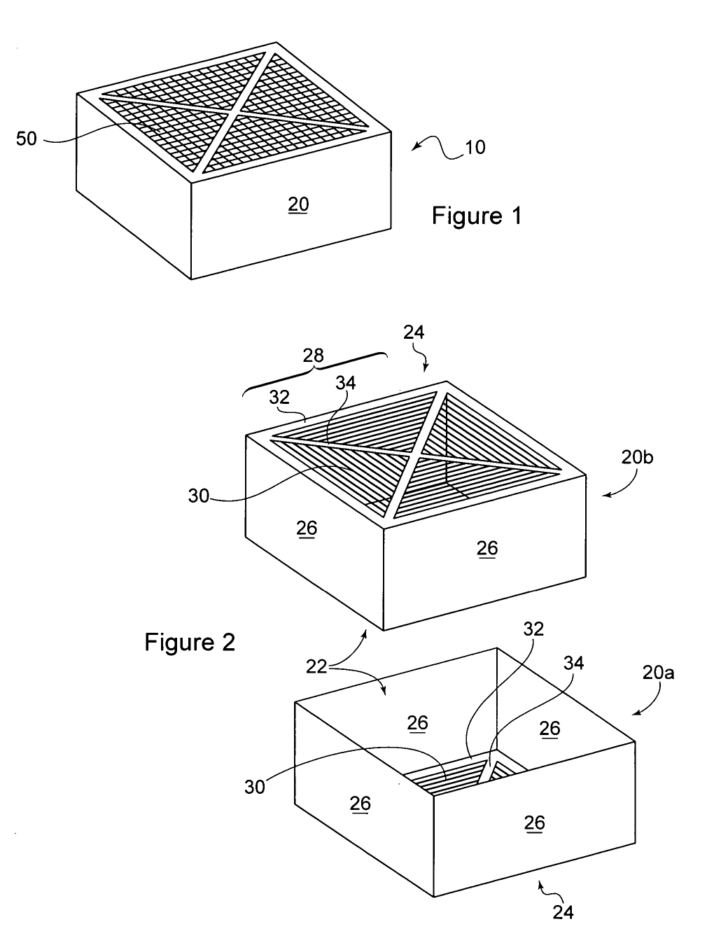

FIG. 1 shows a panel filter assembly 10 according to certain embodiments in an assembled position. As shown; tray member 20 houses the assembly 10. A screen 50 preferably secures filter media in place. An additional tray member may form the lower portion of assembly 10.

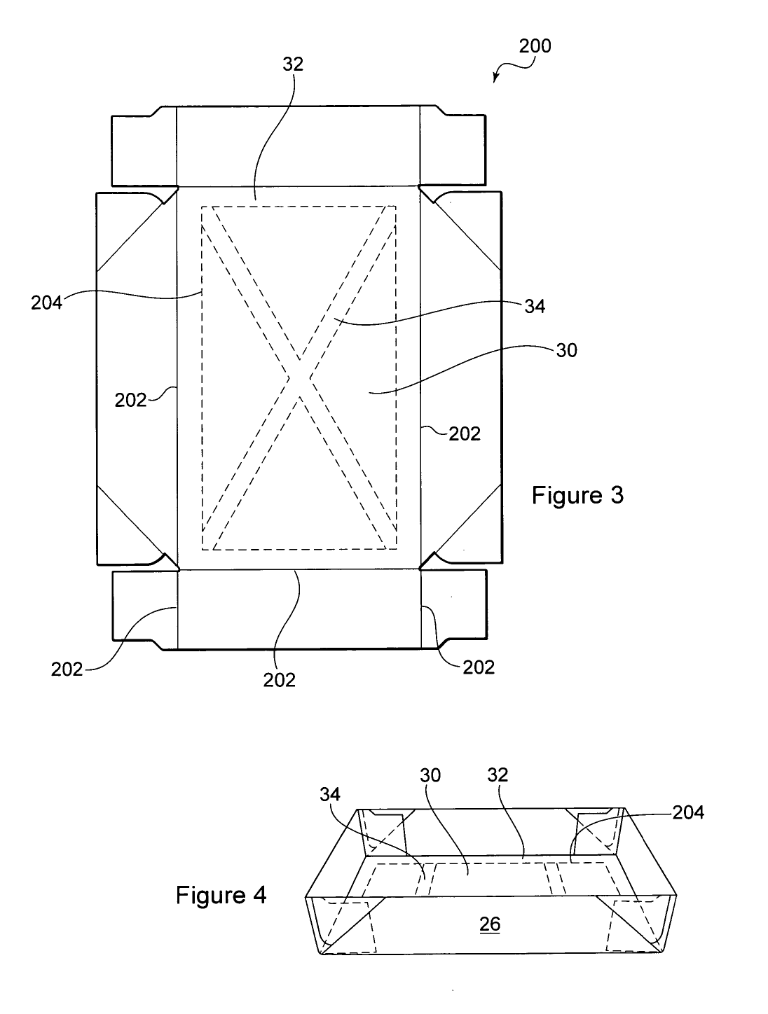

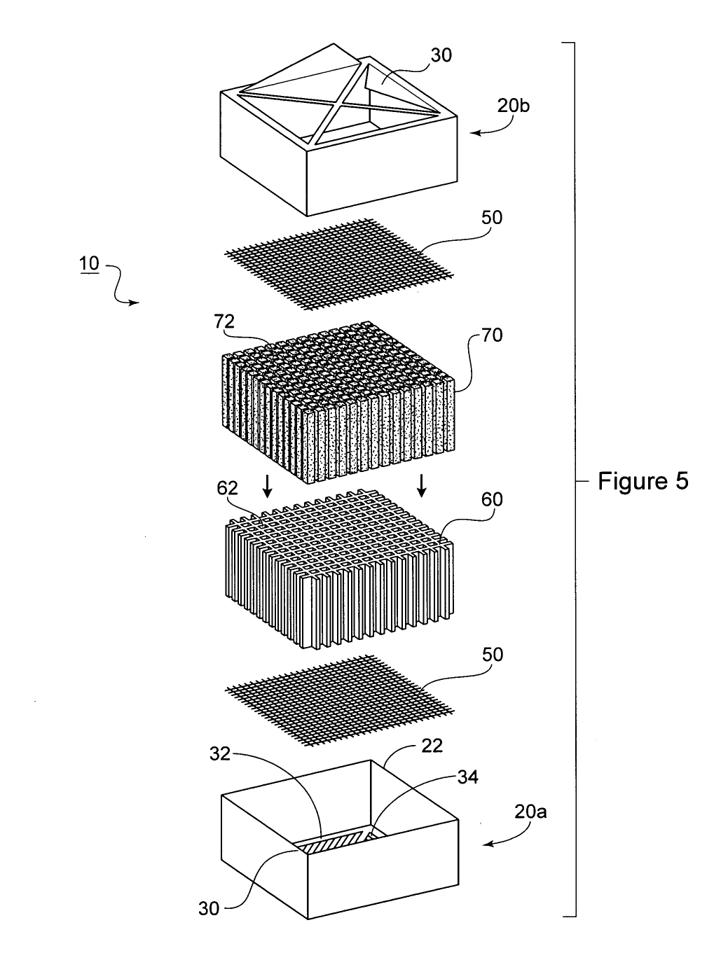

FIG. 2 shows lower tray 20a and upper tray 20b, both of which will be referred to as tray members 20. Lower tray 20a and upper tray 20b have similar features and are made from similar blanks, one example of which is shown in FIGS. 3 and 4 as blank 200, although upper tray 20b may be slightly larger in order to fit over lower tray in a box-type fashion (or vice versa). Although tray members will be described throughout the remainder of this document as separate portions, it should be understood that they may be provided as a one-piece assembly if desired. In the one-piece assembly embodiments, the lower tray 20a forms a lower box portion connected to upper tray 20b, which forms the lip portion.

Tray members 20 are preferably manufactured from a material that has sufficient strength to support the panel filter assembly, but that can be manufactured inexpensively. The material is also preferably lighter than the materials currently used for industrial air filters. According to certain embodiments, tray members 20 are manufactured from a biodegradable material, such as paperboard or corrugated material.

Manufacturing the panel filter assembly 10 out of such materials can reduce the cost of filters by up to 60%. It can also reduce the overall weight and eradicate hazards caused by cuts, scratches, and pinching during installation and removal of the heavier filters that are currently being used.

As shown in FIG. 2, tray members 20 may each be manufactured to have an open face 22 and a closed face 24 prior to assembly. The open and closed faces are preferably formed by walls 26. Open face 22 of lower tray 20a is adapted to receive the components of assembly, described further below, and open face 22 of upper tray 20b is adapted to cover the components and contain them within assembly 10.

Closed faces 24 are formed by supporting members 28 and tear away portions 30. Supporting members 28 may feature a series of ledges 32 and cross members 34. If provided, ledges 32 extend a short distance from either the top or bottom of side walls 26. Cross members 34 are preferably provided for support when tear away portions 30 are removed (which will be described further below). Ledges 32 and cross members 34 of the lower tray 20a are adapted to support additional components of panel filter assembly 10.

The figures show cross members 34 as forming an “X” shape, with the top and bottom of each “X” member extending from a corner of the tray member side walls 26. However, it is understood that any shape that acts to support assembly components is within the scope of this invention, for example, a “t” or “+” shape, a circular shape, a series of strips that extend between side walls 26 (as shown in FIG. 4), a tic-tac-toe-type pattern, and so forth. Additionally, although it is preferred to provide both ledges 32 and cross members 34, it is possible to provide just one of these support features.

Closed faces 24 also feature tear away portions 30. Tear away portions 30, which are illustrated with cross-hatching in FIG. 2, are provided to enclose the filter media housed by tray members 20 during storage and/or shipment, but are adapted to be removed for use. They reduce contamination of the filter media, as well as reduce the amount of filter media that may escape from assembly 10 during shipment.

After assembly of the filter assembly 10 (described below), it is shipped to a retail outlet or directly to the end user. Before installation, the end user will remove tear away panels 30, which can be easily removed from the tray members 20 via push-in corners that lift up and tear along die cut lines before the filter is installed. Other options are available, such as peel away tear away potions that are adhered with a light adhesive, or any other method that allows the temporary securing and ultimate removal of tear away portions.

In one embodiment, tear away portions 30 may be manufactured by providing perforation lines along the edges of tear away portions 30. Upon their removal, tear away portions 30 preferably define cross members 34 and ledges 32 of supporting members 28, which support assembly components. As shown in FIG. 3, the ledges 32, cross members 34 and tear away portions 30 of tray members 20 are formed from blank 200.

According to certain embodiments, the tray member is manufactured by die cutting, erecting, and gluing the four corners beers tray bottom. Both the inner and outer surfaces of blank 200 are printable. Blank 200 preferably includes a series folds 202 and perforated portions 204 (shown in dotted lines). As shown in FIG. 4, the folds 202 are adapted to provide sides 26 upon assembly, and the perforated portions 204 define tear away portions 30. Tear away portions 30 are shown in FIG. 5 as defining an alternate cross member 34 that extends from sides 26.

With tear away portions 30 left in place, the blank can then be collapsed to save space during shipping or storage. In certain embodiments, tray members 20 and other portions of the panel filter assembly are adapted to be manufactured by a packaging company and shipped to a filter manufacturer for full assembly of the panel filter.

FIG. 5 shows the formation of filter assembly 10. During formation, lower tray 20a is assembled, leaving tear away portions 30 intact. A screen 50 is placed into open face 22 of lower tray member 20a and is supported ledges 32, cross members 34, or both. In some embodiments, screen 50 may be glued, tacked or otherwise secured into place.

Screen 50 may be a plastic or wire screen, a mesh screen, a paperboard member with holes, or any other structure that will allow passage or air to be filtered for maximum air flow, but contain or otherwise prevent passage of (most or the majority of or all of) the filter media out of lower tray 20a.

Next, multi-cell partition 60 is placed onto screen 50. Multi-cell partition 60 is preferably made of recyclable paperboard or corrugated material and is adapted to be collapsed during shipping and/or storage. Once inserted into lower tray 20a, it may be expanded to its full size. Each partition 62 is an open cell that is adapted to receive or otherwise house filter media.

A filter or adsorbent media 70 is then preferably loaded into the partition cells 62. The filter media may comprise charcoal pellets, charcoal blocks, crushed charcoal, carbon pads, aluminum polyester filter, cellulose filter, or any other filter media that is usable for the above-described purposes of the filter system 10. FIG. 5 shows filter media as charcoal blocks 72 that are adapted to be inserted into each cell 62.

An additional screen 50 is then glued, tacked or otherwise secured into place on upper tray 20b. Again, screen 50 may preferably be a plastic or wire screen, a mesh screen, a paperboard member with holes, or any other structure that will allow passage or air to be filtered for maximum air flow, but contain or otherwise prevent passage of (most or the majority of or all of) the filter media out of upper tray 20b.

Upper tray 20b is then preferably placed over the assembled components to form a completed filter assembly 10. Tear away portions 30 are left in place until use, although for illustrative purposes, tear away portions 30 are shown being removed in FIG. 5.

One of the advantages of the present invention is that at least the tray members 20 and the multi-cell partition 60 are capable of being manufactured of biodegradable materials that are light and inexpensive. This reduces the weight of the filter and can reduce installation and removal costs and accidents. In certain embodiments, the assembled filter weighs approximately 10 pounds.

The collapsibility of the components 20, 60 also allows them to be manufactured and shipped to a filter manufacturer, who then preferably assembles the filter assembly 10 and ships it to retail or the end user. Once received and before installation, the end user removes the tear away panels 30 that held the filter media 70 in place and contained any loose media that may have settled during shipment. The media remains supported by screens 50, ledges 32, and cross members 34.

Changes and modifications, additions and deletions may be made to the structures and methods recited above and shown in the drawings without departing from the scope or spirit of the invention.

What is claimed is:

1. A panel filter, comprising:
(a) at least one tray member adapted to house the panel filter, the tray member comprising holding structures and tear away panels; and
(b) a multi-cell partition adapted to be disposed within the tray member and adapted to receive a filter media.

2. The panel filter of claim 1, further comprising a first screen that cooperates with the tray member.

3. The panel filter of claim 1, further comprising a filter media.

4. The panel filter of claim 3, wherein the filter media is charcoal.

5. The panel filter of claim 1, wherein the tray member and multi-cell partition are comprised of biodegradable materials.

6. The panel filter of claim 1, wherein the tray members and multi-cell partition are comprised of paperboard or corrugated material.

7. The panel filter of claim 1, wherein the tray member and multi-cell partition are collapsible to facilitate shipping.

8. The panel filter of claim 1, wherein the holding structures comprise ledges and cross members on the tray member to hold filter media in place once the tear away panels are removed.
